(19) United States
(12) Patent Application Publication
(10) Pub. No.: US 2021/0342848 A1
(43) Pub. Date: Nov. 4, 2021

(54) SYSTEM, METHOD, AND APPARATUS FOR MULTI-STAGED RISK SCORING

(71) Applicant: Visa International Service Association, San Francisco, CA (US)

(72) Inventors: Hongqin Song, Austin, TX (US); Yu Gu, Austin, TX (US)

(21) Appl. No.: 17/280,938

(22) PCT Filed: Oct. 5, 2018
(86) PCT No.: PCT/US18/54500

§ 371 Date: Mar. 29, 2021

(51) Int. Cl. G06Q 20/40

(52) U.S. Cl. CPC G06Q 20/4016

(57) ABSTRACT

Provided is a system, method, and apparatus for multi-staged risk scoring. The system includes at least one processor programmed or configured to receive a transaction request message including transaction data, generate a first risk score based at least partially on a first algorithm and a first set of data, determine if the first risk score satisfies a first threshold, in response to determining that the first risk score satisfies the first threshold, process the transaction, in response to determining that the first risk score does not satisfy the first threshold, generate a second risk score based at least partially on a second algorithm and a second set of data different than the first set of data, determine if the second risk score satisfies a second threshold, in response to determining that the second risk score satisfies the second threshold, process the transaction.

### CROSS-REFERENCE TO RELATED APPLICATION

This application is the United States national phase of International Application No. PCT/US2018/054500 filed Oct. 5, 2018, the disclosure of which is hereby incorporated by reference in its entirety.

### BACKGROUND

### 1. Technical Field

This disclosure relates generally to risk scoring and, in non-limiting embodiments, to a system, method, and apparatus for multi-staged risk scoring.

### 2. Technical Considerations

Transaction service providers process and make decisions for thousands of transactions per second. Existing techniques for processing transaction data involve determining a risk score that utilizes valuable processing resources, such as CPU cycles, memory, and bandwidth. Although different transactions may have different levels of risk, existing risk scoring processes employ the same algorithms for every transaction. These existing risk scoring processes are inefficient and use unnecessary computing resources.

On one hand, it is desirable to use as many data parameters as possible to generate a trustworthy score. On the other hand, each additional data parameter utilizes additional computing resources. Existing techniques for generating a risk score for a transaction use static values for the amount and type of data used to generate the risk score. Thus, existing techniques may either use more data than necessary or less data than desired for generating a risk score.

### SUMMARY

According to non-limiting embodiments, provided is a computer-implemented method for multi-staged risk scoring, including at least one transaction processing system including at least one processor programmed or configured to: receive a transaction request message comprising transaction data; generate a first risk score based at least partially on a first algorithm and a first set of data; determine if the first risk score satisfies a first threshold; in response to determining that the first risk score satisfies the first threshold, process the transaction; in response to determining that the first risk score does not satisfy the first threshold, generate a second risk score based at least partially on a second algorithm and a second set of data different than the first set of data; determine if the second risk score satisfies a second threshold; and in response to determining that the second risk score satisfies the second threshold, process the transaction.

In non-limiting embodiments of the system, the at least one processor is further programmed or configured to: in response to determining that the second risk score does not satisfy the first threshold, generate a third risk score based at least partially on a third algorithm and a third set of data different than the first set of data and the second set of data; determine if the third risk score satisfies a third threshold; and in response to determining that the third risk score satisfies the third threshold, process the transaction.

In non-limiting embodiments of the system, at least one of the second set of data and the third set of data comprises at least one parameter received from an external third-party system. In non-limiting embodiments, the at least one parameter comprises a reputation score. In non-limiting embodiments, the second set of data is a subset of the third set of data. In non-limiting embodiments, the first set of data is a subset of the second set of data. In non-limiting embodiments, the second set of data comprises at least one parameter received from an external third-party system. In non-limiting embodiments, the at least one parameter comprises a reputation score. In non-limiting embodiments, the first set of data comprises a first portion of the transaction data, and the second set of data comprises a second portion of the transaction data.

According to non-limiting embodiments, provided is a computer program product for multi-staged risk scoring, including at least one non-transitory computer readable medium including program instructions that, when executed by at least one processor, cause the at least one processor to: receive a transaction request message comprising transaction data; generate a first risk score based at least partially on a first algorithm and a first set of data; determine if the first risk score satisfies a first threshold; in response to determining that the first risk score satisfies the first threshold, process the transaction; in response to determining that the first risk score does not satisfy the first threshold, generate a second risk score based at least partially on a second algorithm and a second set of data different than the first set of data; determine if the second risk score satisfies a second threshold; and in response to determining that the second risk score satisfies the second threshold, process the transaction.

In non-limiting embodiments of the computer program product, the program instructions further cause the at least one processor to: in response to determining that the second risk score does not satisfy the first threshold, generate a third risk score based at least partially on a third algorithm and a third set of data different than the first set of data and the second set of data; determine if the third risk score satisfies a third threshold; and in response to determining that the third risk score satisfies the third threshold, process the transaction.

In non-limiting embodiments of the computer program product, at least one of the second set of data and the third set of data comprises at least one parameter received from an external third-party system. In non-limiting embodiments, the at least one parameter comprises a reputation score. In non-limiting embodiments, the second set of data is a subset of the third set of data. In non-limiting embodiments, the first set of data is a subset of the second set of data. In non-limiting embodiments, the second set of data comprises at least one parameter received from an external third-party system. In non-limiting embodiments, the at least one parameter comprises a reputation score. In non-limiting embodiments, the first set of data comprises a first portion of the transaction data, and the second set of data comprises a second portion of the transaction data.

According to non-limiting embodiments, provided is a computer-implemented method for multi-staged risk scoring, including: receiving a transaction request message comprising transaction data; generating a first risk score based at least partially on a first algorithm and a first set of data; determining if the first risk score satisfies a first threshold; in response to determining that the first risk score does not satisfy the first threshold, generating a second risk score based at least partially on a second algorithm and a second set of data different than the first set of data; determining if the second risk score satisfies a second threshold; and in response to determining that the second risk score satisfies the second threshold or a subsequent risk score satisfies a subsequent threshold, processing the transaction.

In non-limiting embodiments of the method, the transaction is processed in response to determining that the subsequent risk score satisfies a subsequent threshold, wherein the subsequent risk score comprises a third risk score, the subsequent threshold comprises a third threshold, and the method further includes generating the third risk score in response to determining that the second risk score does not satisfy the second threshold.

In non-limiting embodiments of the method, at least one of the second set of data and the third set of data comprises at least one parameter received from an external third-party system. In non-limiting embodiments, the at least one parameter comprises a reputation score. In non-limiting embodiments, the second set of data is a subset of the third set of data, and the first set of data is a subset of the second set of data.

Further non-limiting embodiments or aspects are set forth in the following numbered clauses.

Clause 1: A system for multi-staged risk scoring, comprising at least one transaction processing system including at least one processor programmed or configured to: receive a transaction request message comprising transaction data; generate a first risk score based at least partially on a first algorithm and a first set of data; determine if the first risk score satisfies a first threshold; in response to determining that the first risk score satisfies the first threshold, process the transaction; in response to determining that the first risk score does not satisfy the first threshold, generate a second risk score based at least partially on a second algorithm and a second set of data different than the first set of data; determine if the second risk score satisfies a second threshold; and in response to determining that the second risk score satisfies the second threshold, process the transaction.

Clause 2: The system of clause 1, wherein the at least one processor is further programmed or configured to: in response to determining that the second risk score does not satisfy the first threshold, generate a third risk score based at least partially on a third algorithm and a third set of data different than the first set of data and the second set of data; determine if the third risk score satisfies a third threshold; and in response to determining that the third risk score satisfies the third threshold, process the transaction.

Clause 3: The system of clauses 1 or 2, wherein at least one of the second set of data and the third set of data comprises at least one parameter received from an external third-party system.

Clause 4: The system of any of clauses 1-3, wherein the at least one parameter comprises a reputation score.

Clause 5: The system of any of clauses 1-4, wherein the second set of data is a subset of the third set of data.

Clause 6: The system of any of clauses 1-5, wherein the first set of data is a subset of the second set of data.

Clause 7: The system of any of clauses 1-6, wherein the second set of data comprises at least one parameter received from an external third-party system.

Clause 8: The system of any of clauses 1-7, wherein the at least one parameter comprises a reputation score.

Clause 9: The system of any of clauses 1-8, wherein the first set of data comprises a first portion of the transaction data, and wherein the second set of data comprises a second portion of the transaction data.

Clause 10: A computer program product for multi-staged risk scoring, comprising at least one non-transitory computer readable medium including program instructions that, when executed by at least one processor, cause the at least one processor to: receive a transaction request message comprising transaction data; generate a first risk score based at least partially on a first algorithm and a first set of data; determine if the first risk score satisfies a first threshold; in response to determining that the first risk score satisfies the first threshold, process the transaction; in response to determining that the first risk score does not satisfy the first threshold, generate a second risk score based at least partially on a second algorithm and a second set of data different than the first set of data; determine if the second risk score satisfies a second threshold; and in response to determining that the second risk score satisfies the second threshold, process the transaction.

Clause 11: The computer program product of clause 10, wherein the program instructions further cause the at least one processor to: in response to determining that the second risk score does not satisfy the first threshold, generate a third risk score based at least partially on a third algorithm and a third set of data different than the first set of data and the second set of data; determine if the third risk score satisfies a third threshold; and in response to determining that the third risk score satisfies the third threshold, process the transaction.

Clause 12: The computer program product of clauses 10 or 11, wherein at least one of the second set of data and the third set of data comprises at least one parameter received from an external third-party system.

Clause 13: The computer program product of any of clauses 10-12, wherein the at least one parameter comprises a reputation score.

Clause 14: The computer program product of any of clauses 10-13, wherein the second set of data is a subset of the third set of data.

Clause 15: The computer program product of any of clauses 10-14, wherein the first set of data is a subset of the second set of data.

Clause 16: The computer program product of any of clauses 10-15, wherein the second set of data comprises at least one parameter received from an external third-party system.

Clause 17: The computer program product of any of clauses 10-16, wherein the at least one parameter comprises a reputation score.

Clause 18: The computer program product of any of clauses 10-17, wherein the first set of data comprises a first portion of the transaction data, and wherein the second set of data comprises a second portion of the transaction data.

Clause 19: A computer-implemented method for multi-staged risk scoring, comprising: receiving a transaction request message comprising transaction data; generating a first risk score based at least partially on a first algorithm and a first set of data; determining if the first risk score satisfies a first threshold; in response to determining that the first risk score does not satisfy the first threshold, generating a second risk score based at least partially on a second algorithm and a second set of data different than the first set of data; determining if the second risk score satisfies a second threshold; and in response to determining that the second risk score satisfies the second threshold or a subsequent risk score satisfies a subsequent threshold, processing the transaction.

Clause 20: The computer-implemented method of clause 19, wherein the transaction is processed in response to determining that the subsequent risk score satisfies a subsequent threshold, wherein the subsequent risk score comprises a third risk score based on a third set of data, wherein the subsequent threshold comprises a third threshold, and wherein the method further comprises generating the third risk score in response to determining that the second risk score does not satisfy the second threshold.

Clause 21: The computer-implemented method of clauses 19 or 20, wherein at least one of the second set of data and the third set of data comprises at least one parameter received from an external third-party system.

Clause 22: The computer-implemented method of any of clauses 19-21, wherein the at least one parameter comprises a reputation score.

Clause 23: The computer-implemented method of any of clauses 19-22, wherein the second set of data is a subset of the third set of data, and wherein the first set of data is a subset of the second set of data.

These and other features and characteristics of non-limiting embodiments, as well as the methods of operation and functions of the related elements of structures and the combination of parts, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise.

### BRIEF DESCRIPTION OF THE DRAWINGS

Additional advantages and details of non-limiting embodiments are explained in greater detail below with reference to the exemplary embodiments that are illustrated in the accompanying schematic figures, in which:

FIG. 1 is a schematic diagram of a system for multi-staged risk scoring according to non-limiting embodiments of the present disclosure;

FIG. 2 is a schematic diagram of a system for multi-staged risk scoring according to non-limiting embodiments of the present disclosure;

FIG. 3 is a flow diagram of a method for multi-staged risk scoring according to non-limiting embodiments of the present disclosure; and

FIG. 4 is a schematic diagram of example components of a device or system according to non-limiting embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. The term “transaction service provider” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” may refer to one or more entities, such as a bank, that provide accounts to customers for conducting payment transactions, such as initiating credit and/or debit payments. For example, an issuer institution may provide an account identifier, such as a personal account number (PAN), to a customer that uniquely identifies one or more accounts associated with that customer. The account identifier may be embodied on a physical financial instrument, such as a payment card, and/or may be electronic and used for electronic payments. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes. An issuer institution may be associated with a Bank Identification Number (BIN) or other unique identifier that uniquely identifies it among other issuer institutions.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “portable financial device” may refer to a payment device, an electronic payment device, a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a personal digital assistant, a security card, an access card, a wireless terminal, and/or a transponder, as examples. The portable financial device may include a volatile or a non-volatile memory to store information, such as an account identifier or a name of the account holder.

Non-limiting embodiments are directed to a system, method, and computer program product for generating a risk score using a multi-stage approach and external data (e.g., a reputation score). In non-limiting embodiments, the use of computer processing resources is reduced by utilizing a first stage in which only a subset of data is used to generate a risk score, such as an account identifier, such that additional stages that consider additional data, associated with additional processing resources, are only initiated and performed if the first stage or a subsequent stage is insufficient.

In tests of non-limiting embodiments, various efficiencies were realized over existing risk scoring methodologies. For example, with one example set of data and using non-limiting embodiments, the average processing time for calculating a risk score was 2.02 milliseconds for all transactions with an average accuracy of 97.79%. In this test, three stages were utilized in which: stage 1 was completed in 2 milliseconds with a 98% accuracy and returned an acceptable risk score 90% of the time; stage 2 was completed in 2 milliseconds with a 96% accuracy and returned an acceptable risk score 9% of the time (or 90% of all results that were not satisfied at stage 1); and stage 3 was completed in 4 milliseconds with a 95% accuracy and returned an acceptable risk score for the remainder of the results (1% in this test). This is compared to existing risk scoring systems which, when tested with the same, took 4 milliseconds for all transactions with a 95% accuracy.

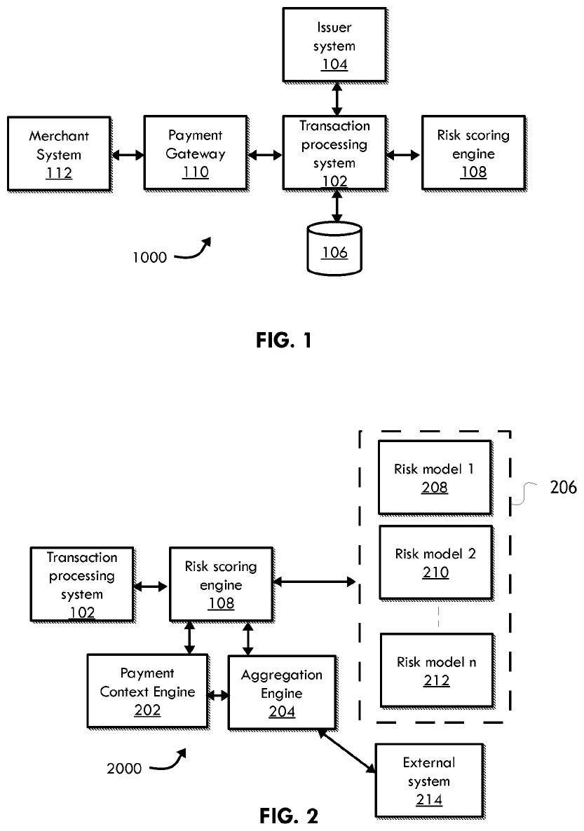

Referring now to FIG. 1, a schematic diagram of a system 1000 for multi-staged risk scoring is shown according to non-limiting embodiments. The system 1000 includes an electronic payment processing network including a transaction processing system 102 in communication with one or more merchant systems 112, payment gateways 110, and issuer systems 104. The transaction processing system 102 may receive transaction request messages from a merchant system 112 directly or from a payment gateway 110 and/or acquirer system on behalf of a merchant. The transaction request messages may be initiated by consumers at merchant systems 112, such as POS systems, e-commerce webpages, and/or the like, using one or more portable financial devices. The transaction processing system 102 generates an authorization request message and communicates the authentication request message to an issuer system 104. In response to receiving an authorization response message from the issuer system 104, the transaction processing system completes the transaction or rejects the transaction request.

In the non-limiting embodiment shown in FIG. 1, the transaction processing system 102 includes or is in communication with one or more data storage devices 106 storing transaction data and account data. For example, transaction data may include a history of transactions associated with account identifiers, transaction values, transaction times, BINs, Merchant Category Codes (MCC), and/or the like. Account data may include, for example, account identifiers associated with customer information, account types, account limits, and/or the like.

Still referring to FIG. 1, the transaction processing system 102 may receive a transaction request message including transaction data from the merchant system 112. The transaction processing system 102 may communicate the transaction data to the data storage device 106 for storage and may also communicate some or all of the transaction data to a risk scoring engine 108. The risk scoring engine 108 may include one or more software applications or functions executed by the transaction processing system 102 or any other system or device in communication with the transaction processing system 102. The risk scoring engine 108 may generate a first risk score based on a first set of transaction data communicated from the transaction processing system 102 and a first risk score algorithm. After generating the first risk score, the transaction processing system 102 determines if the first risk score satisfies a first threshold. For example, the transaction processing system 102 may determine that the risk score is less than or equal to a first threshold and, in response to that determination, may process the transaction and forego additional stages of risk scoring.

Still referring to FIG. 1, in response to the transaction processing system 102 determining that the risk score does not satisfy the first threshold, the transaction processing system 102 proceeds to a second stage in which the risk scoring engine 108 generates a second risk score based at least partially on a second set of the transaction data communicated from the transaction processing system 102 that is different than the first set of transaction data used to generate the first risk score. In non-limiting embodiments, the second set of data used to generate the second risk score includes the first set of data such that the first set of data is a subset of the second set of data. The second risk score may also be generated based on a different risk scoring algorithm than was used to generate the first risk score. After generating the second risk score, the transaction processing system 102 determines if the second risk score satisfies a second threshold. For example, the transaction processing system 102 may determine that the second risk score is less than or equal to a second threshold and, in response to that determination, may process the transaction and forego additional stages of risk scoring.

With continued reference to FIG. 1, in non-limiting embodiments, in response to the transaction processing system 102 determining that the second risk score does not satisfy the second threshold, the transaction processing system 102 may proceed to a third stage in which the risk scoring engine 108 generates a third risk score based at least partially on a third set of the transaction data communicated from the transaction processing system 102 that is different than the first and/or second set of transaction data used to generate the first and/or second risk score. In non-limiting embodiments, the third set of data used to generate the third risk score includes the second set of data such that the second set of data is a subset of the third set of data. The third risk score may also be generated based on a different risk scoring algorithm than was used to generate the first and/or second risk score. After generating the third risk score, the transaction processing system 102 determines if the third risk score satisfies a third threshold. For example, the transaction processing system 102 may determine that the third risk score is less than or equal to a third threshold and, in response to that determination, may process the transaction and forego additional stages of risk scoring. In response to the transaction processing system 102 determining that the third risk score does not satisfy the third threshold, the transaction processing system 102 may proceed to a next stage or may reject the transaction. It will be appreciated that non-limiting embodiments may involve the generation of two or more risk scores in two or more stages, and that any other number of stages and variations of parameters and sets of transaction data may be used.

In non-limiting embodiments, the second risk score and/or third risk score is generated based at least partially on one or more parameters of data received from an external system, such as a third-party service provider. As an example, a reputation score from a social media system or reputation service provider may be used to generate the second risk score and/or subsequent risk scores.

Referring now to FIG. 2, a schematic diagram of a system 2000 for multi-staged risk scoring is shown according to non-limiting embodiments. In response to receiving a request for a risk score from the transaction processing system 102, the risk scoring engine 108 may obtain payment context data from a payment context engine 202. Payment context data may include, for example, an account identifier, Internet Protocol (IP) address, device identifier (e.g., MAC address or the like), user identifier, geographical location, merchant identifier, and/or other like context data for a payment transaction. In non-limiting embodiments, the payment context engine 202 invokes an aggregation engine 204 to aggregate a plurality of data parameters from internal and external sources. For example, the aggregation engine 204 may be in communication with an external system 214, such as a server for a reputation management system, to obtain third-party data. The payment context engine 202 and/or the aggregation engine 204 may include one or more software applications or functions executed by the transaction processing system 102 or any other system in communication with the transaction processing system 102. In non-limiting embodiments, the payment context engine 202 and/or the aggregation engine 204 may be part of the risk scoring engine 108.

With continued reference to FIG. 2, a plurality of risk models 206 includes a risk model 208, 210, 212 for each stage of the multi-staged risk scoring algorithm. Each model 208, 210, 212 may include one or more algorithms and/or risk scoring rules for generating a risk score. As an example, each risk model 208, 210, 212 may specify the data parameters that are used for each corresponding stage and the risk scoring algorithm that is used to process those parameters, such as weighting factors for each parameter to generate a score. Although different risk models 208, 210, 212 are shown for each stage of a multi-stage risk scoring process, it will be appreciated that one or more stages of a plurality of stages may use the same risk model.

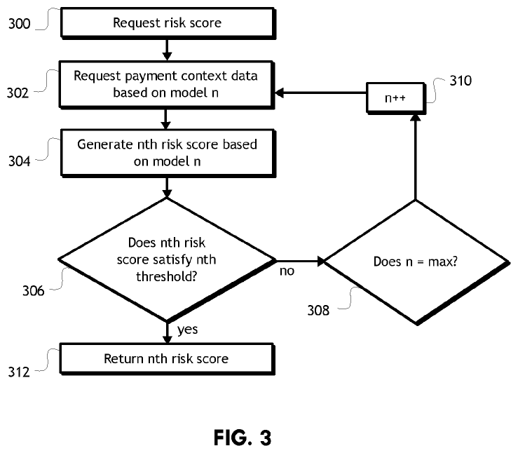

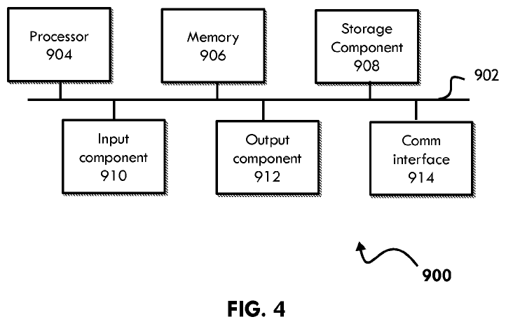

Referring now to FIG. 3, a method for multi-staged risk scoring is shown according to non-limiting embodiments. The steps of the method shown may be carried out by one or more processors of a transaction processing system or any other system or device. The method shown in FIG. 3 is for a method that uses n stages, where n is any integer value equal to or exceeding two (2). At a first step 300, a request is received to return a risk score. A request for a risk score may be received, for example, from a risk scoring engine from a transaction processing system and/or issuer system. The request may be a message that includes transaction data such as, for example, an account identifier (e.g., a PAN), a transaction amount, a transaction date, a device identifier, and/or other transaction data. At step 300, n is equal to one (1).

Still referring to FIG. 3, at step 302, payment context data is requested for an nth risk scoring model. For example, for the first iteration through the method and after step 300, step 302 may identify a first risk model and a first set of payment context data parameters for the first risk model and request those payment context data parameters. In non-limiting embodiments, a risk scoring engine, after receiving a request for a risk score, passes the request or makes an additional request to a payment context engine. The payment context engine may then return payment context data associated with that particular risk scoring model (i.e., the nth risk scoring model). As described herein, the payment context engine may receive payment context data from an aggregation engine, which in turn collects payment context data from an external source.

With continued reference to FIG. 3, at a next step 304, a risk score is generated based on the nth risk scoring model. For example, for the first iteration through the method, a first risk score may be generated based on a first risk model. The transaction data and payment context data used for generating the nth risk score may therefore depend upon the nth risk model. As an example, a reputation score received from an external system may be used in the second and/or third risk models. At step 306, it is determined whether the risk score generated at step 304 (i.e., the nth risk score) is acceptable. For example, it may be determined whether the nth risk score satisfies a threshold, such as an nth threshold. If the nth risk score is determined to be acceptable at step 306, the method proceeds to step 312 and the nth risk score is returned. If the nth risk score is not acceptable at step 306, the method proceeds to step 308 and it is determined if n is the maximum number of stages. For example, for the first iteration through the method where n=1, it will be determined that n does not equal or exceed a maximum number of stages (e.g., two or more stages). If there are additional stages to perform, the method proceeds to step 310 and the value of n is incremented. As described herein, there may be two, three, or more stages, each stage with a corresponding risk scoring model.

Still referring to FIG. 3, after the counter is incremented at step 310, the method continues to step 302 for processing the nth stage and payment context data is requested for an nth risk scoring model. To the extent that some or all of the payment context data for the nth risk scoring model was used for a previous stage, that payment context data may not need to be requested. The method continues looping between steps 302 and 310 until the nth risk score is acceptable at step 306 or until the maximum number of stages is reached at step 308. It will be appreciated that various other conditions may also or instead cause the method to be terminated. Once the loop is terminated, at step 306, step 308, or at some other time, the method may end at step 312 in which the nth and final risk score is returned.

Referring now to FIG. 4, shown is a diagram of example components of a device 900 according to non-limiting embodiments. Device 900 may correspond to one or more devices of transaction provider system 102, risk scoring engine 108, and/or issuer system 104. In some non-limiting embodiments, such systems may include at least one device 900 and/or at least one component of device 900. The number and arrangement of components shown in FIG. 4 are provided as an example. In some non-limiting embodiments, device 900 may include additional components, fewer components, different components, or differently arranged components than those shown in FIG. 4. Additionally, or alternatively, a set of components (e.g., one or more components) of device 900 may perform one or more functions described as being performed by another set of components of device 900.

As shown in FIG. 4, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 4, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although non-limiting embodiments have been described in detail for the purpose of illustration, it is to be understood that such detail is solely for that purpose and that the embodiments are intended to cover modifications and equivalent arrangements that are within the spirit and scope of the appended claims. For example, it is to be understood that, to the extent possible, one or more features of any embodiment can be combined with one or more features of any other embodiment.

1. A system for multi-staged risk scoring, comprising at least one transaction processing system including at least one processor programmed or configured to:
receive a transaction request message comprising transaction data;
generate a first risk score based at least partially on a first algorithm and a first set of data;
determine if the first risk score satisfies a first threshold;
in response to determining that the first risk score satisfies the first threshold, process the transaction;
in response to determining that the first risk score does not satisfy the first threshold, generate a second risk score based at least partially on a second algorithm and a second set of data different than the first set of data;
determine if the second risk score satisfies a second threshold; and
in response to determining that the second risk score satisfies the second threshold, process the transaction.

2. The system of claim 1, wherein the at least one processor is further programmed or configured to:
in response to determining that the second risk score does not satisfy the first threshold, generate a third risk score based at least partially on a third algorithm and a third set of data different than the first set of data and the second set of data;
determine if the third risk score satisfies a third threshold; and
in response to determining that the third risk score satisfies the third threshold, process the transaction.

3. The system of claim 2, wherein at least one of the second set of data and the third set of data comprises at least one parameter received from an external third-party system.

4. The system of claim 3, wherein the at least one parameter comprises a reputation score.

5. The system of claim 3, wherein the second set of data is a subset of the third set of data.

6. The system of claim 1, wherein the first set of data is a subset of the second set of data.

7. The system of claim 1, wherein the second set of data comprises at least one parameter received from an external third-party system.

8. The system of claim 7, wherein the at least one parameter comprises a reputation score.

9. The system of claim 1, wherein the first set of data comprises a first portion of the transaction data, and wherein the second set of data comprises a second portion of the transaction data.

10. A computer program product for multi-staged risk scoring, comprising at least one non-transitory computer readable medium including program instructions that, when executed by at least one processor, cause the at least one processor to:
receive a transaction request message comprising transaction data;
generate a first risk score based at least partially on a first algorithm and a first set of data;
determine if the first risk score satisfies a first threshold;
in response to determining that the first risk score satisfies the first threshold, process the transaction;
in response to determining that the first risk score does not satisfy the first threshold, generate a second risk score based at least partially on a second algorithm and a second set of data different than the first set of data;
determine if the second risk score satisfies a second threshold; and
in response to determining that the second risk score satisfies the second threshold, process the transaction.

11. The computer program product of claim 10, wherein the program instructions further cause the at least one processor to:
in response to determining that the second risk score does not satisfy the first threshold, generate a third risk score based at least partially on a third algorithm and a third set of data different than the first set of data and the second set of data;
determine if the third risk score satisfies a third threshold; and
in response to determining that the third risk score satisfies the third threshold, process the transaction.

12. The computer program product of claim 11, wherein at least one of the second set of data and the third set of data comprises at least one parameter received from an external third-party system.

13. The computer program product of claim 12, wherein the at least one parameter comprises a reputation score.

14. The computer program product of claim 12, wherein the second set of data is a subset of the third set of data.

15. The computer program product of claim 10, wherein the first set of data is a subset of the second set of data.

16. The computer program product of claim 10, wherein the second set of data comprises at least one parameter received from an external third-party system.

17. The computer program product of claim 16, wherein the at least one parameter comprises a reputation score.

18. The computer program product of claim 10, wherein the first set of data comprises a first portion of the transaction data, and wherein the second set of data comprises a second portion of the transaction data.

19. A computer-implemented method for multi-staged risk scoring, comprising:
receiving a transaction request message comprising transaction data;
generating a first risk score based at least partially on a first algorithm and a first set of data;
determining if the first risk score satisfies a first threshold;
in response to determining that the first risk score does not satisfy the first threshold, generating a second risk score based at least partially on a second algorithm and a second set of data different than the first set of data;
determining if the second risk score satisfies a second threshold; and
in response to determining that the second risk score satisfies the second threshold or a subsequent risk score satisfies a subsequent threshold, processing the transaction.

20. The computer-implemented method of claim 19, wherein the transaction is processed in response to determining that the subsequent risk score satisfies a subsequent threshold, wherein the subsequent risk score comprises a third risk score based on a third set of data, wherein the subsequent threshold comprises a third threshold, and wherein the method further comprises generating the third risk score in response to determining that the second risk score does not satisfy the second threshold.

21.-23. (canceled)
